(19) United States
(12) Patent Application Publication
(10) Pub. No.: US 2025/0392522 A1
(43) Pub. Date: Dec. 25, 2025

(54) SYSTEMS AND METHODS FOR A CLOUD-ORCHESTRATED AI/ML EXECUTION PLATFORM

(71) Applicant: PLUME DESIGN, INC., Palo Alto, CA (US)

(72) Inventors: Stephen H. GRAU, Pleasanton, CA (US); Badri Srinivasan SAMPATHKUMAR, Fremont, CA (US)

(21) Appl. No.: 18/753,170

(22) Filed: Jun. 25, 2024

(51) Int. Cl. H04L 41/16; H04L 43/022; H04W 24/02; H04W 84/12

(52) U.S. Cl. CPC H04L 41/16; H04L 43/022; H04W 24/02; H04W 84/12

(57) ABSTRACT

Disclosed are computerized systems and methods for a highly scalable, cloud-based AI/ML execution platform. The disclosed systems and methods provide a computerized framework that can generate and execute AI/ML models that provide agile, real-time predictions that can facilitate, cause and/or provide instructions for high-fidelity, real-time management of a multitude of cloud-based WiFi network locations, inclusive of the access points and/or user equipment operating therefrom/therein. The framework can cause a ML model to be trained that is then executed to generate a location-specific AI model that can then be executed to predict how a network can and/or should be configured based on current characteristics at the location, which can then be managed and put into place on at the location via the framework.

### FIELD OF THE DISCLOSURE

The present disclosure relates to a decision intelligence (DI)-based computerized framework for a scalable, cloud-based artificial intelligence/machine learning (AI/ML) execution platform.

### SUMMARY OF THE DISCLOSURE

Disclosed are computerized systems and methods for a highly scalable, cloud-based AI/ML execution platform. As discussed herein, the disclosed systems and methods provide a computerized framework that can generate and execute AI/ML models that provide agile, real-time predictions that can facilitate, cause and/or provide instructions for high-fidelity, real-time management of a multitude of cloud-based Wireless Fidelity (Wi-Fi or WiFi, used interchangeably) network locations.

According to some embodiments, the disclosed framework provide a computerized network-based (and/or network-hosted) framework that can monitor and record real-time data at high frequencies (e.g., at or above threshold frequencies for sampling) for access points (APs) located at the edge of a network(s). In some embodiments, as provided herein, the disclosed framework can upload selected snapshots of recent history to the cloud (e.g., on demand, when triggered by an event and/or according to other forms of criteria, discussed infra). Such histories can be used as training data for both supervised and unsupervised ML models to generate location-specific AI models. In some embodiments, each location-specific model can be downloaded to APs at the location, where such models can be executed by a prediction engine executing on and/or in accordance with each AP to perform real-time network management and control decisions.

By way of a non-limiting example, according to some embodiments, client devices can be steered to more favorable (and/or optimized) WiFi APs (or radios) as the client devices physically move within their location. Accordingly, as detailed herein, the disclosed framework provides functionality to learn and predict the optimal times (and/or positions/places) to steer each client respective to such clients' movements within their locations. Moreover, such predictions, and the actions based therefrom, can correspond to location-specific characteristics that are related to, but not limited to, the structure of the building (e.g., rooms, hallways, doorways, floorplan, layout, stories, square footage, building materials, and the like), placement and capabilities of the APs in and/or around the location, frequency and timing of human activity, device types and capabilities (e.g., which radios can be used for certain devices), and the like, or some combination thereof.

Thus, as discussed herein, the disclosed systems and methods provide improved computerized mechanisms for a cloud-orchestrated platform to manage a network at a location, which can impact how devices can connect to such network and/or the characteristics of such network, inter alia.

According to some embodiments, a method is disclosed for a scalable, cloud-based AI/ML execution platform. In accordance with some embodiments, the present disclosure provides a non-transitory computer-readable storage medium for carrying out the above-mentioned technical steps of the framework's functionality. The non-transitory computer-readable storage medium has tangibly stored thereon, or tangibly encoded thereon, computer readable instructions that when executed by a device cause at least one processor to perform a method for scalable, cloud-based AI/ML execution platform.

In accordance with one or more embodiments, a system is provided that includes one or more processors and/or computing devices configured to provide functionality in accordance with such embodiments. In accordance with one or more embodiments, functionality is embodied in steps of a method performed by at least one computing device. In accordance with one or more embodiments, program code (or program logic) executed by a processor(s) of a computing device to implement functionality in accordance with one or more such embodiments is embodied in, by and/or on a non-transitory computer-readable medium.

### DESCRIPTIONS OF THE DRAWINGS

The features and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure:

FIG. 1A is a block diagram of an example configuration within which the systems and methods disclosed herein could be implemented according to some embodiments of the present disclosure;

FIG. 1B is a block diagram illustrating components of an exemplary system according to some embodiments of the present disclosure;

FIG. 2 depicts a non-limiting example embodiments according to some embodiments of the present disclosure;

FIG. 3 illustrates an exemplary workflow according to some embodiments of the present disclosure;

FIG. 4 depicts an exemplary implementation of an architecture according to some embodiments of the present disclosure;

FIG. 5 depicts an exemplary implementation of an architecture according to some embodiments of the present disclosure; and

FIG. 6 is a block diagram illustrating a computing device showing an example of a client or server device used in various embodiments of the present disclosure.

### DETAILED DESCRIPTION

The present disclosure will now be described more fully hereinafter with reference to the accompanying drawings, which form a part hereof, and which show, by way of non-limiting illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

For the purposes of this disclosure a non-transitory computer readable medium (or computer-readable storage medium/media) stores computer data, which data can include computer program code (or computer-executable instructions) that is executable by a computer, in machine readable form. By way of example, and not limitation, a computer readable medium may include computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, optical storage, cloud storage, magnetic storage devices, or any other physical or material medium which can be used to tangibly store the desired information or data or instructions and which can be accessed by a computer or processor.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

For the purposes of this disclosure a “network” should be understood to refer to a network that may couple devices so that communications may be exchanged, such as between a server and a client device or other types of devices, including between wireless devices coupled via a wireless network, for example. A network may also include mass storage, such as network attached storage (NAS), a storage area network (SAN), a content delivery network (CDN) or other forms of computer or machine-readable media, for example. A network may include the Internet, one or more local area networks (LANs), one or more wide area networks (WANs), wire-line type connections, wireless type connections, cellular or any combination thereof. Likewise, sub-networks, which may employ different architectures or may be compliant or compatible with different protocols, may interoperate within a larger network.

For purposes of this disclosure, a “wireless network” should be understood to couple client devices with a network. A wireless network may employ stand-alone ad-hoc networks, mesh networks, Wireless LAN (WLAN) networks, cellular networks, or the like. A wireless network may further employ a plurality of network access technologies, including Wi-Fi, Long Term Evolution (LTE), WLAN, Wireless Router mesh, or 2nd, 3rd, 4^{th} or 5^{th} generation (2G, 3G, 4G or 5G) cellular technology, mobile edge computing (MEC), Bluetooth, 802.11b/a/g/n/ac/ax/be, or the like. Network access technologies may enable wide area coverage for devices, such as client devices with varying degrees of mobility, for example.

In short, a wireless network may include virtually any type of wireless communication mechanism by which signals may be communicated between devices, such as a client device or a computing device, between or within a network, or the like.

A computing device may be capable of sending or receiving signals, such as via a wired or wireless network, or may be capable of processing or storing signals, such as in memory as physical memory states, and may, therefore, operate as a server. Thus, devices capable of operating as a server may include, as examples, dedicated rack-mounted servers, desktop computers, laptop computers, set top boxes, integrated devices combining various features, such as two or more features of the foregoing devices, or the like.

For purposes of this disclosure, a client (or user, entity, subscriber or customer) device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Near Field Communication (NFC) device, a Personal Digital Assistant (PDA), a handheld computer, a tablet computer, a phablet, a laptop computer, a set top box, a wearable computer, smart watch, an integrated or distributed device combining various features, such as features of the forgoing devices, or the like.

A client device may vary in terms of capabilities or features. Claimed subject matter is intended to cover a wide range of potential variations, such as a web-enabled client device or previously mentioned devices may include a high-resolution screen (HD or 4K for example), one or more physical or virtual keyboards, mass storage, one or more accelerometers, one or more gyroscopes, global positioning system (GPS) or other location-identifying type capability, or a display with a high degree of functionality, such as a touch-sensitive color 2D or 3D display, for example.

Certain embodiments and principles will be discussed in more detail with reference to the figures. By way of background, in conventional systems, access points are capable of sampling, aggregating and reporting data at a low frequency to a cloud service, where the cloud can then make decisions using static algorithms built into the cloud software. Alternatives of such current systems involve access points implementing simplistic rules, such as low or high signal strength thresholds to trigger client steering actions.

Therefore, there is a need for a highly scalable, cloud-based AI/ML execution platform that can generate and execute AI/ML models that provide agile, real-time predictions for purposes of facilitating high-fidelity, real-time management of a multitude of cloud-based WiFi network locations.

According to some embodiments, as discussed herein, the disclosed framework can incorporate location specific knowledge, such as, for example, roaming patterns within a location, into computer (AI/ML) models that can then be used to make decisions specific to each location—for example, determining and acting upon the opportune time to steer a client device from one access point to another as the client device moves down a hallway from one area of a home to another.

In some embodiments, as provided herein, the framework provides capabilities for execution of the computer models at the edge, in access points, which enables the computer models to execute on high frequency data and produce management and control decisions with low latency. Moreover, execution of the models at the edge in access points is scalable, in that as new access points are added to a location, the framework's “reach” can be increased via the range of such access points. Indeed, execution of the computer models at the edge eliminates the need to transmit large amounts of data over the network to accomplish network management and control tasks, thereby avoiding loading of the network with management and control related data (e.g., a reduction of network resources).

Accordingly, the disclosed systems and methods provided framework enables models to be built, customized, or some combination thereof, to specific locations, which can take into account common roaming patterns, structural aspects of the location (patterns of motion, which may limited by hallways, doorways, and the like), placement of access points at the location, and the like. As discussed herein, for example, a computer model executing on an access point can yield a low latency decision at close to the optimal time to steer a client to another access point rather than a decision that is delayed until signal strength gets too low or the cloud performs its next periodic evaluation.

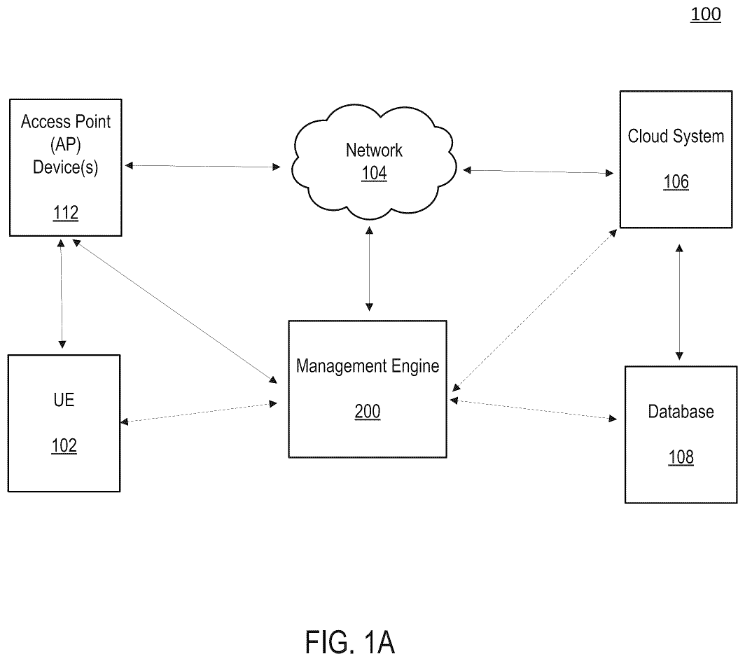

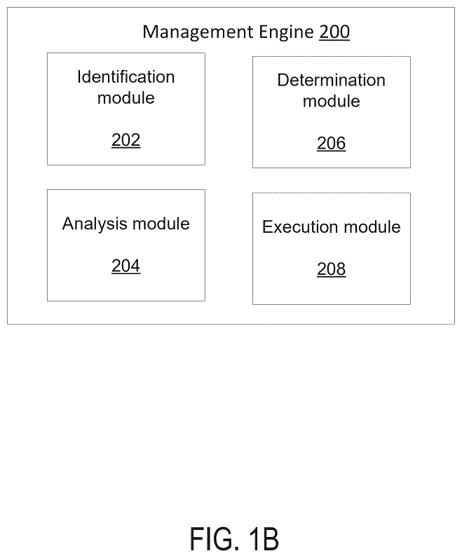

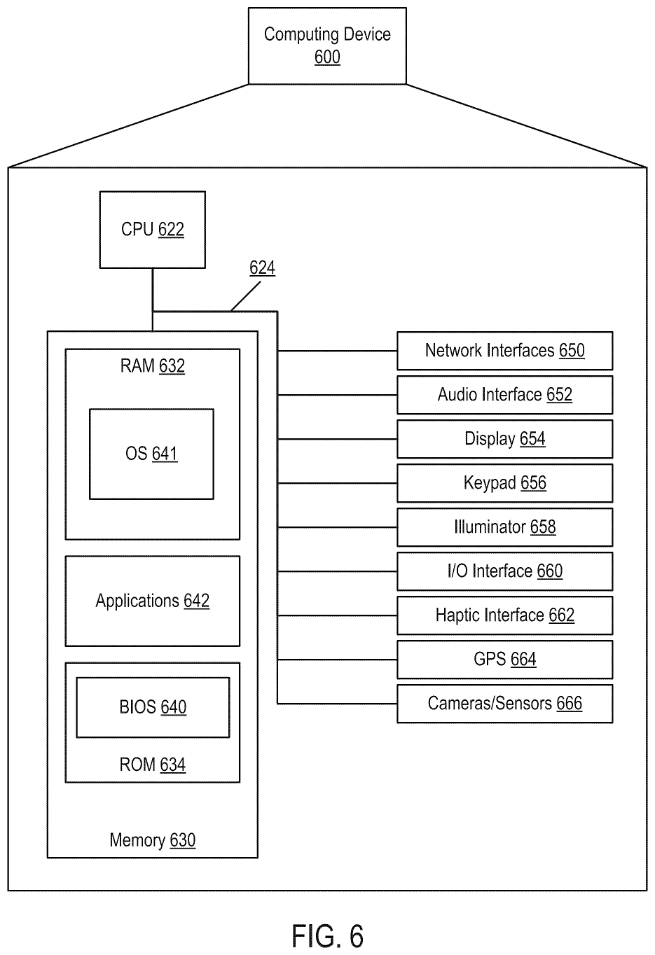

With reference to FIG. 1A, system 100 is depicted which includes user equipment (UE) 102 (e.g., a client device, as mentioned above and discussed below in relation to FIG. 6), AP device 112, network 104, cloud system 106, database 108 and execution engine 200. It should be understood that while system 100 is depicted as including such components, it should not be construed as limiting, as one of ordinary skill in the art would readily understand that varying numbers of UEs, AP devices, peripheral devices, sensors, cloud systems, databases and networks can be utilized; however, for purposes of explanation, system 100 is discussed in relation to the example depiction in FIG. 1A.

According to some embodiments, UE 102 can be any type of device, such as, but not limited to, a mobile phone, tablet, laptop, sensor, Internet of Things (IoT) device, wearable device, autonomous machine, smart television, media streaming device, game console, and any other device equipped with a cellular or wireless or wired transceiver. In some embodiments, UE 102 can be an access point.

In some embodiments, peripheral devices (not shown) can be connected to UE 102, and can be any type of peripheral device, such as, but not limited to, a wearable device (e.g., smart ring, smart watch, for example), printer, speaker, sensor, and the like. In some embodiments, a peripheral device can be any type of device that is connectable to UE 102 via any type of known or to be known pairing mechanism, including, but not limited to, WiFi, Bluetooth™, Bluetooth Low Energy (BLE), NFC, and the like.

In some embodiments, UE 102 can correspond to, but not be limited to, any type of device, component and/or sensor associated with a location of system 100 (referred to, collectively, as “sensors”). In some embodiments, the UE 102 can be any type of device that is capable of sensing and capturing data/metadata related to activity of the location. For example, the UE 102 can include, but not be limited to, cameras, motion detectors, door and window contacts, heat and smoke detectors, passive infrared (PIR) sensors, time-of-flight (ToF) sensors, and the like. In some embodiments, the sensors can be associated with devices associated with the location of system 100, such as, for example, lights, smart locks, garage doors, smart appliances (e.g., thermostat, refrigerator, television, personal assistants (e.g., Alexa®, Nest®, for example)), smart phones, smart watches or other wearables, tablets, personal computers, and the like, and some combination thereof. In some embodiments, UE 102 can be associated with any device connected and/or operating on cloud system 106 (e.g., a cloud-based device, such as a server that collects information related to the location, for example).

According to some embodiments, AP device 112 is a device that creates and/or provides a wireless local area network (WLAN) for the location. According to some embodiments, the AP device 112 can be, but is not limited to, a router, switch, hub, gateway, extender and/or any other type of network hardware that can project a WiFi signal to a designated area. In some embodiments, UE 102 may be an AP device.

In some embodiments, network 104 can be any type of network, such as, but not limited to, a wireless network, cellular network, the Internet, and the like (as discussed above). Network 104 facilitates connectivity of the components of system 100, as illustrated in FIG. 1.

According to some embodiments, cloud system 106 may be any type of cloud operating platform and/or network based system upon which applications, operations, and/or other forms of network resources may be located. For example, system 106 may be a service provider and/or network provider from where services and/or applications may be accessed, sourced or executed from. For example, system 106 can represent the cloud-based architecture associated with a smart home or network provider (e.g., Plume Design®, for example), which has associated network resources hosted on the internet or private network (e.g., network 104), which enables (via engine 200) the network management discussed herein.

In some embodiments, cloud system 106 may include a server(s) and/or a database of information which is accessible over network 104. In some embodiments, a database 108 of cloud system 106 may store a dataset of data and metadata associated with local and/or network information related to a user(s) of the components of system 100 and/or each of the components of system 100 (e.g., UE 102, AP device 112, and the services and applications provided by cloud system 106 and/or execution engine 200).

In some embodiments, for example, cloud system 106 can provide a private/proprietary management platform, whereby engine 200, discussed infra, corresponds to the novel functionality system 106 enables, hosts and provides to a network 104 and other devices/platforms operating thereon.

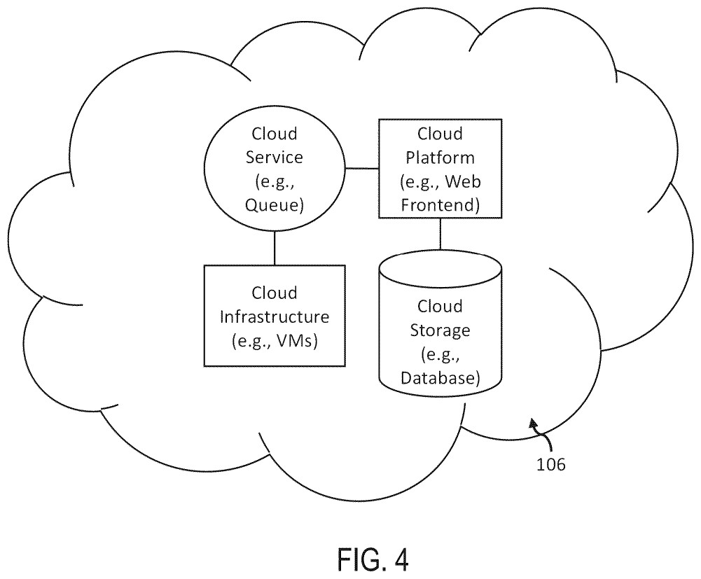

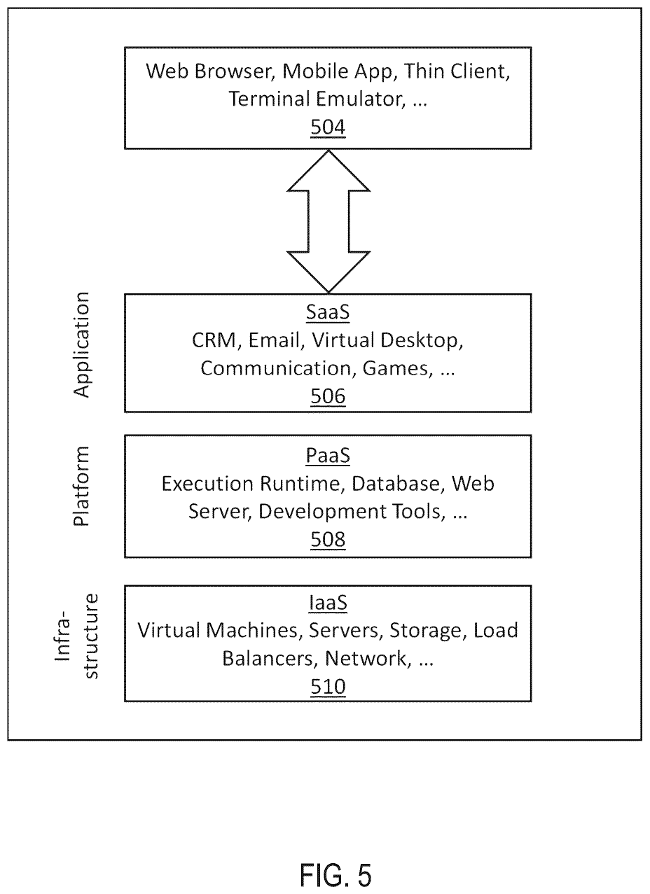

Turning to FIGS. 4 and 5, in some embodiments, the exemplary computer-based systems/platforms, the exemplary computer-based devices, and/or the exemplary computer-based components of the present disclosure may be specifically configured to operate in a cloud computing/architecture 106 such as, but not limiting to: infrastructure as a service (IaaS) 510, platform as a service (PaaS) 508, and/or software as a service (SaaS) 506 using a web browser, mobile app, thin client, terminal emulator or other endpoint 504. FIGS. 4 and 5 illustrate schematics of non-limiting implementations of the cloud computing/architecture(s) in which the exemplary computer-based systems for administrative customizations and control of network-hosted application program interfaces (APIs) of the present disclosure may be specifically configured to operate.

Turning back to FIG. 1A, according to some embodiments, database 108 may correspond to a data storage for a platform (e.g., a network hosted platform, such as cloud system 106, as discussed supra) or a plurality of platforms. Database 108 may receive storage instructions/requests from, for example, engine 200 (and associated microservices), which may be in any type of known or to be known format, such as, for example, structured query language (SQL). According to some embodiments, database 108 may correspond to any type of known or to be known storage, for example, a memory or memory stack of a device, a distributed ledger of a distributed network (e.g., blockchain, for example), a look-up table (LUT), and/or any other type of secure data repository.

Execution engine 200, as discussed above and further below in more detail, can include components for the disclosed functionality. According to some embodiments, execution engine 200 may be a special purpose machine or processor, and can be hosted by a device on network 104, within cloud system 106, on AP device 112 and/or on UE 102. In some embodiments, engine 200 may be hosted by a server and/or set of servers associated with cloud system 106.

According to some embodiments, as discussed in more detail below, execution engine 200 may be configured to implement and/or control a plurality of services and/or microservices, where each of the plurality of services/microservices are configured to execute a plurality of workflows associated with performing the disclosed network management. Non-limiting embodiments of such workflows are discussed and provided below.

According to some embodiments, as discussed above, execution engine 200 may function as an application provided by cloud system 106. In some embodiments, engine 200 may function as an application installed on a server(s), network location and/or other type of network resource associated with system 106. In some embodiments, engine 200 may function as an application installed and/or executing on AP device 112 and/or UE 102. In some embodiments, such application may be a web-based application accessed by AP device 112 and/or UE 102, and/or devices accessible over network 104 from cloud system 106. In some embodiments, engine 200 may be configured and/or installed as an augmenting script, program or application (e.g., a plug-in or extension) to another application or program provided by cloud system 106 and/or executing on AP device 112 and/or UE 102. Accordingly, as provided below, engine 200 can execute on a device, at a network location, on nodes of a network and/or across a network, on differing components to perform the operations of each module executing therein.

As illustrated in FIG. 1B, according to some embodiments, execution engine 200 includes identification module 202, analysis module 204, determination module 206 and execution module 208. It should be understood that the engine(s) and modules discussed herein are non-exhaustive, as additional or fewer engines and/or modules (or sub-modules) may be applicable to the embodiments of the systems and methods discussed. More detail of the operations, configurations and functionalities of engine 200 and each of its modules, and their role within embodiments of the present disclosure will be discussed below.

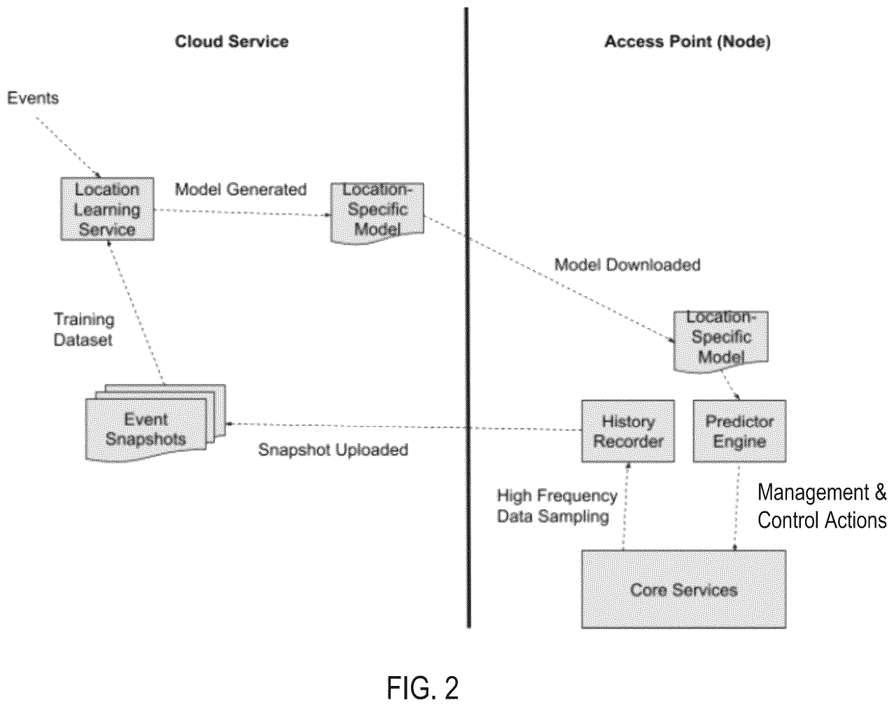

Turning to FIG. 2, depicted is a non-limiting example embodiment for the cloud-orchestrated network location control and management. As depicted in FIG. 2, cloud components can manage Wi-Fi network services at a multitude of locations (for example, homes). The Wi-Fi network services at each location can be provided by one or more access points, which can be, for example, arranged in a mesh topology (e.g., if there are multiple access points). FIG. 2 depicts only one access point for simplicity; however, it should be understood that many locations can have multiple access points, each having multiple Wi-Fi radios supporting various frequency bands, without departing from the scope of the instant application.

Access Points typically have access to large amounts of data related to the core networking services they provide—for example, client signal strength, data rates being used by clients, and the like. As discussed herein, and depicted in FIG. 2, a history recorder function associated with (e.g. in) the access point that records data at high frequency into a limited size buffer can be utilized. According to some embodiments, the history buffer can be configured as a circular buffer, with new data replacing the oldest data, for example.

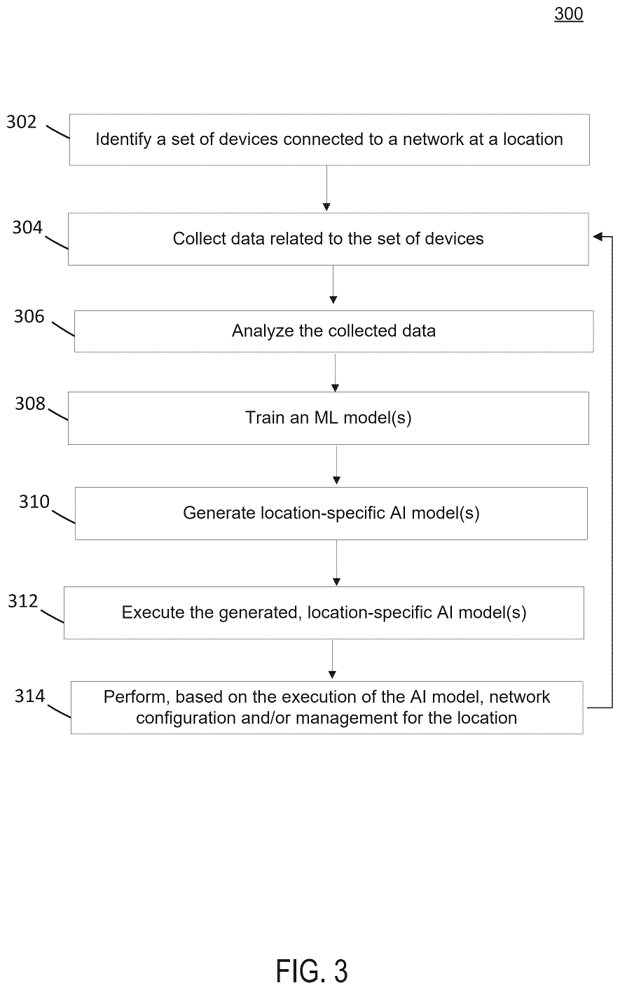

According to some embodiments, as discussed with reference to FIG. 3, infra, when events of interest occur and are detected, a full snapshot of the recorded history or a filtered snapshot can be captured and uploaded to the cloud and labeled with event information. According to some embodiments, snapshots can be recorded over time, creating a dataset of many events.

According to some embodiments, as depicted in FIG. 2, and discussed in more detail in relation to FIG. 3, infra, a location learning engine can utilize the collection of snapshots as a training and test dataset to train location-specific models using ML techniques, as discussed below. According to some embodiments, such location-specific models can make predictions about actions to take to manage network activity at locations in real-time, which can cause modifications to the way the network is configured and/or organized.

According to some embodiments, as discussed in more detail below, such location-specific models can be downloaded into the access point(s) at the location, whereby a known or to be known prediction (or predictor, used interchangeably) engine can execute the model in real-time. According to some embodiments, as discussed herein, such execution of the model corresponds to ML techniques where the model is trained from many observations, for example, photographs label whether they contain a traffic signal or not, then later is executed by inputting a new observation(s)—for example, a new photo, from which it makes a prediction (e.g., whether the photo contains a traffic signal or not, for example)

Accordingly, as discussed below, such models can be used to make predictions, such as in the non-limiting example of predicting the access point that will provide the service that satisfies a service threshold (“a best service”—e.g., at least meeting or surpassing values for throughput, bandwidth, and the like) for a client device at a current time. Such predictions can then be used to trigger network management/control actions, which can include, but are not limited to, steering the client to the access point that is predicted to provide the “best” service.

According to some embodiments, executing the models at the edge of the network enables the model(s) to operate on high frequency data and respond to events with low latency. Additionally, executing the models at the edge provides inherent scaling, leveraging the compute power of access points, as well as the additional compute capacity that is added with each new access point added to the network/location.

According to some embodiments, the disclosed framework can involve the computation of new and/or updated models for access points with additional computing resources, which can correspond to, but not be limited to, additional memory, additional processing cores, increased clock speed, one or more graphics processing units (GPUs), ad/or special purpose processors tailored for AI and machine learning tasks, and the like, or some combination thereof.

Thus, turning to FIG. 2, a non-limiting example, involves an event being detected by the cloud service, where the location learning service of the cloud can detect the event (e.g., a device at a location moving, an access point being added, the network signing up for services, a new UE connecting, and the like). This data can be provided as an event snapshot for purposes of being training data enabled via upload to the history recorded, discussed supra. Further, the history recorder can further perform high frequency data sampling of the core services, for which further events and/or snapshots can be collected and used to update and/or train the model or other models.

In some embodiments, the location learning service can generate a location specific model based on the event data and the trained model, which, as provided below, can involve an ML model generating the AI-based location-specific model. As discussed above, such model can be downloaded (or provided via a web-service) to a location-specific modal associated with the access point, as depicted in FIG. 2 and discussed in more detail below. Such modal can operate by providing the downloaded/accessed model to the predictor engine to manage and control actions of the core services of the access point (e.g., provide connectivity curated for each device and the networking environment at the location, as discussed infra).

Accordingly, in some embodiments, with reference to FIG. 1B and FIG. 2, the identification module 202 can perform, and/or enable the collection of data, events and/or snapshot information, as discussed in more detail below. In some embodiments, analysis module 204 can be executed and/or called to perform the analysis of the event and/or snapshot information, as well as the ML analysis performed to train the model and generate the AI model. Model 204 can further be implemented via the predictor to execute the AI to analyze the event and/or snapshot information. Accordingly, determination module 206 can be called or executed to perform the determination of the ML and/or AI models, whereby the execution of such models, via the predictor and management/control of the network can be effectuated via execution model 208.

Thus, while engine 200 is depicted as a single engine, as discussed above, it can be configured as a disparate, connected system/engine with modules that execute on the cloud and in connection with the access point(s) to enable the control and/or management of the network at the location of the access point.

Turning to FIG. 3, Process 300 provides non-limiting example embodiments for the disclosed cloud-based orchestration framework. As discussed herein, the disclosed systems and methods provide a computerized framework that can generate and execute AI/ML models that provide agile, real-time predictions that can facilitate, cause and/or provide instructions for high-fidelity, real-time management of a multitude of cloud-based WiFi network locations, inclusive of the access points and/or user equipment operating therefrom/therein. Thus, as provided below, the operations of engine 200, as mentioned above respective to FIGS. 1A-2, can cause a ML model to be trained that is then executed to generate a location-specific AI model that can then be executed to predict how a network can and/or should be configured based on current characteristics at the location, which can then be managed and put into place at the location.

According to some embodiments, Steps 302 and 304 of Process 300 can be performed by identification module 202 of execution engine 200; Step 306 can be performed by analysis module 204; Steps 308-310 can be performed by determination module 206; and Steps 312 and 314 can be performed by execution module 208.

According to some embodiments, Process 300 begins with Step 302 where engine 200 can identify a set of devices connected to a network (e.g., WiFi) associated with a location. In some embodiments, the set of devices can include, but are not limited to, APs, UEs, and the like (e.g., gateway devices, routers, extenders, and the like, or some combination thereof, for example), or some combination thereof.

In some embodiments, the set of devices can be devices that are connected to a network associated with the location, and/or connect to the network at least a threshold amount of times per a threshold amount of time (e.g., connects to the network at least 25 times per month, thereby indicating they live at the location).

According to some embodiments, a location can correspond to, but is not limited to, a home, office, building, and/or any other type of physical location that can be configured to host and/or provide network connectivity to devices in/around the geographic area. Accordingly, in some embodiments, the network, as discussed above, can be any type of communication network (e.g., a location-based or associated network such as a Wi-Fi network, for example) that can enable devices to automatically connect upon being within range of the location and/or access point devices providing the network at/around the location.

In some embodiments, Step 302 can further involve the identification of information, which can include, but is not limited to, a type of device, identity (ID) of device, MAC address or IP address of the device, user account associated the device, and the like, or some combination thereof.

In Step 304, for each device within the identified set of devices (from Step 302), engine 200 can collect device information (e.g., data/metadata). Such collection can be performed periodically according to a criteria (e.g., time, date, interval, request, and the like, or some combination thereof), continuously, and/or according to the detection of an event (e.g., detecting a device connecting to the network, detecting a device disconnecting to the network, detecting a device being added/removed from the network, and the like, as discussed above in relation to at least FIG. 2).

In some embodiments, such collected information can be based on, but not limited to, a device ID, device type and/or designation (e.g., primary routers, repeaters, endpoints, and the like), device capabilities, connectivity data (e.g., signal strength, signal quality, throughput, latency, bandwidth, and the like), connectivity type (e.g., which type of radio—for example, 2.4 GHZ, 5 GHz and/or 6 GHz, for example; supported WiFi Standards (e.g., 802.11n, 802.11ac, 802.11ax); WiFi generations (e.g., WiFi 5/6/7, and the like) number of antennas (MIMO capabilities), and the like. Thus, a comprehensive set of device information can be collected for which an understanding of a required network configuration can be determined, as discussed herein.

In some embodiments, the collected data can further or alternatively indicate location-specific characteristics that are related to, but not limited to, the structure of the building (e.g., rooms, hallways, doorways, floorplan, layout, stories, square footage, building materials, and the like), placement and capabilities of the APs in and/or around the location, frequency and timing of human activity, and the like, or some combination thereof.

In Step 306, engine 200 can analyze the device information (from Step 304). As provided herein, such analysis can be for purposes of training the ML model(s) based on the collected information (e.g., based on snapshot information) and/or determining/generating (and/or updating) a location-specific AI model. Accordingly, in some embodiments, such collected information can correspond to an event and/or a snapshot of network activity data, as discussed above. Thus, as discussed above with relation to FIG. 2, this information can be i) provided to the history recorder and ii) provided to the location specific model for analysis via a ML-based model (e.g., location specific model, as in FIG. 2, discussed supra.

According to some embodiments, such analysis can operate on the cloud, whereby the ML model can be called and executed via engine 200 running on cloud system 106, as per FIG. 1, for example. According to some embodiments, such ML model can be a specifically trained ML model, a particular machine learning model architecture, a particular machine learning model type (e.g., convolutional neural network (CNN), recurrent neural network (RNN), autoencoder, support vector machine (SVM), and the like), or any other suitable definition of a machine learning model or any suitable combination thereof.

In some embodiments, engine 200 may be configured to utilize one or more ML techniques selected from, but not limited to, computer vision, feature vector analysis, decision trees, boosting, support-vector machines, neural networks, nearest neighbor algorithms, Naive Bayes, bagging, random forests, logistic regression, and the like.

In some embodiments and, optionally, in combination of any embodiment described above or below, a neural network technique may be one of, without limitation, feedforward neural network, radial basis function network, recurrent neural network, convolutional network (e.g., U-net) or other suitable network. In some embodiments and, optionally, in combination of any embodiment described above or below, an implementation of Neural Network may be executed as follows:
a) define Neural Network architecture/model,
b) transfer the input data to the neural network model,
c) train the model incrementally,
d) determine the accuracy for a specific number of timesteps,
c) apply the trained model to process the newly received input data,
f) optionally and in parallel, continue to train the trained model with a predetermined periodicity.

In some embodiments and, optionally, in combination of any embodiment described above or below, the trained neural network model may specify a neural network by at least a neural network topology, a series of activation functions, and connection weights. For example, the topology of a neural network may include a configuration of nodes of the neural network and connections between such nodes. In some embodiments and, optionally, in combination of any embodiment described above or below, the trained neural network model may also be specified to include other parameters, including but not limited to, bias values/functions and/or aggregation functions. For example, an activation function of a node may be a step function, sine function, continuous or piecewise linear function, sigmoid function, hyperbolic tangent function, or other type of mathematical function that represents a threshold at which the node is activated. In some embodiments and, optionally, in combination of any embodiment described above or below, the aggregation function may be a mathematical function that combines (e.g., sum, product, and the like) input signals to the node. In some embodiments and, optionally, in combination of any embodiment described above or below, an output of the aggregation function may be used as input to the activation function. In some embodiments and, optionally, in combination of any embodiment described above or below, the bias may be a constant value or function that may be used by the aggregation function and/or the activation function to make the node more or less likely to be activated.

Thus, based on the analysis of the collected device information, in Step 308 engine 200 can involve training the ML model to operate as a location specific model for the specific location.

According to some embodiments, performing ML operations in the cloud enables the framework (e.g., engine 200) to leverage powerful and highly efficient data center computing resources tailored to machine learning tasks. Cloud-based learning avoids the need for complex communications between nodes. Instead, the ML model in the cloud can integrate insights gained from devices (e.g., access point(s) and UE(s)) at a location into a model that can be executed autonomously.

Accordingly, in some embodiments, a ML model can be developed through a systematic process involving the training on historical network data. Initially, a comprehensive dataset can be collected, containing various network metrics such as bandwidth usage, latency, packet loss, device status, and incident logs, including timestamps and the corresponding corrective actions taken (e.g., collected data from Step 304). This data can be preprocessed to handle missing values, normalize features, and split into training and testing sets.

During the training phase (Step 308), the ML model, which could be based on algorithms such as decision trees, support vector machines, or neural networks, can be fed this dataset. Supervised learning techniques can be employed, where the model learns to map input features (e.g., current network conditions) to target outputs (e.g., optimal corrective actions). This can involve using labeled data where each training example is paired with the desired output, allowing the model to learn from past events.

According to some embodiments, such training process can involve iterative optimization, where the model's parameters are adjusted to minimize a loss function, which can involve using gradient descent methods, for example. Techniques like cross-validation can be used to ensure the model generalizes well to unseen data. Hyperparameter tuning, potentially involving grid search or random search, can be conducted to determine the model configuration that corresponds to the location and the requirements as indicated via the collected data.

Once trained, the model can be validated using the testing set to evaluate its performance metrics such as accuracy, precision, recall, and Fl score. Any overfitting or underfitting issues can be addressed via techniques, such as, for example, regularization or by obtaining more data. The final model, now encapsulated in a deployable format, can be integrated into the network management framework. When executed, the model can be configured to ingest real-time network data through monitoring tools and APIs. The model can process this data and apply its learned patterns to detect anomalies, predict potential issues, and recommend or automatically execute corrective actions, as well as enable network configurations and/or topologies. For example, if the model detects a pattern indicative of an impending bandwidth bottleneck, the model may suggest reallocating resources or rerouting traffic to mitigate the issue.

In Step 310, engine 200 can, via the trained ML model, generate the location-specific AI model(s). Once sufficiently trained, the ML model's learned parameters can be used to initialize or generate a deployable AI model, which can be communicated and downloaded to the access point(s) at the location. Such AI model is configured to operate by taking new input data representing the current state of the network, and based on its training, determine and/or prescribe actions to take to manage the network effectively for the given scenario/time as indicated by the input data.

In Step 312, engine 200 can cause the AI model downloaded to the access point to be executed. Such execution, as discussed in relation to FIG. 2 above can be effectuated via a prediction engine causing the operation of the AI model. The AI model can be configured to accept real-time network telemetry data as input, and analyze such streaming data to detect (or predict) patterns that map to different network events. Based on the detected event, the AI model can then trigger predefined automation workflows. Accordingly, the downloaded, AP-executed AI model, can operate in an automated manner, continuously (and/or periodically) monitoring the network, analyzing data, and executing management actions, such as, but not limited to, provisioning resources, updating configurations, mitigating threats, optimizing performance, and the like, which can all be to the specific requirements of the current network state at the location. The AI model essentially acts as an intelligent control plane, continuously analyzing the network and executing remediation actions without human intervention.

And, in Step 314, engine 200 can cause the performance, based on the execution of the AI model (in Step 312), network configuration and management for the location. As discussed above, such configuration and management can involve, but is not limited to, provisioning resources, updating configurations, mitigating threats, optimizing performance, and the like. Such automated decision-making process enhances network management by providing timely, data-driven insights and actions, thereby optimizing network performance, reducing downtime, and ensuring a more resilient and efficient network infrastructure for the location.

FIG. 6 is a schematic diagram illustrating a client device showing an example embodiment of a client device that may be used within the present disclosure. Client device 600 may include many more or less components than those shown in FIG. 6. However, the components shown are sufficient to disclose an illustrative embodiment for implementing the present disclosure. Client device 600 may represent, for example, UE 102 discussed above at least in relation to FIG. 1A.

As shown in the figure, in some embodiments, Client device 600 includes a processing unit (CPU) 622 in communication with a mass memory 630 via a bus 624. Client device 600 also includes a power supply 626, one or more network interfaces 650, an audio interface 652, a display 654, a keypad 656, an illuminator 658, an input/output interface 660, a haptic interface 662, an optional global positioning systems (GPS) receiver 664 and a camera(s) or other optical, thermal or electromagnetic sensors 666. Device 600 can include one camera/sensor 666, or a plurality of cameras/sensors 666, as understood by those of skill in the art. Power supply 626 provides power to Client device 600.

Client device 600 may optionally communicate with a base station (not shown), or directly with another computing device. In some embodiments, network interface 650 is sometimes known as a transceiver, transceiving device, or network interface card (NIC).

Audio interface 652 is arranged to produce and receive audio signals such as the sound of a human voice in some embodiments. Display 654 may be a liquid crystal display (LCD), gas plasma, light emitting diode (LED), or any other type of display used with a computing device. Display 654 may also include a touch sensitive screen arranged to receive input from an object such as a stylus or a digit from a human hand.

Keypad 656 may include any input device arranged to receive input from a user. Illuminator 658 may provide a status indication and/or provide light.

Client device 600 also includes input/output interface 660 for communicating with external. Input/output interface 660 can utilize one or more communication technologies, such as USB, infrared, Bluetooth™, or the like in some embodiments. Haptic interface 662 is arranged to provide tactile feedback to a user of the client device.

Optional GPS transceiver 664 can determine the physical coordinates of Client device 600 on the surface of the Earth, which typically outputs a location as latitude and longitude values. GPS transceiver 664 can also employ other geo-positioning mechanisms, including, but not limited to, triangulation, assisted GPS (AGPS), E-OTD, CI, SAI, ETA, BSS or the like, to further determine the physical location of client device 600 on the surface of the Earth. In one embodiment, however, Client device 600 may through other components, provide other information that may be employed to determine a physical location of the device, including for example, a MAC address, Internet Protocol (IP) address, or the like.

Mass memory 630 includes a RAM 632, a ROM 634, and other storage means. Mass memory 630 illustrates another example of computer storage media for storage of information such as computer readable instructions, data structures, program modules or other data. Mass memory 630 stores a basic input/output system (“BIOS”) 640 for controlling low-level operation of Client device 600. The mass memory also stores an operating system 641 for controlling the operation of Client device 600.

Memory 630 further includes one or more data stores, which can be utilized by Client device 600 to store, among other things, applications 642 and/or other information or data. For example, data stores may be employed to store information that describes various capabilities of Client device 600. The information may then be provided to another device based on any of a variety of events, including being sent as part of a header (e.g., index file of the HLS stream) during a communication, sent upon request, or the like. At least a portion of the capability information may also be stored on a disk drive or other storage medium (not shown) within Client device 600.

Applications 642 may include computer executable instructions which, when executed by Client device 600, transmit, receive, and/or otherwise process audio, video, images, and enable telecommunication with a server and/or another user of another client device. Applications 642 may further include a client that is configured to send, to receive, and/or to otherwise process gaming, goods/services and/or other forms of data, messages and content hosted and provided by the platform associated with engine 200 and its affiliates.

According to some embodiments, certain aspects of the instant disclosure can be embodied via functionality discussed herein, as disclosed supra. According to some embodiments, some non-limiting aspects can include, but are not limited to the below method aspects, which can additionally be embodied as system, apparatus and/or device functionality:
Aspect 1. A method comprising:
   collecting, over a network, data related to a set of devices at a location, the data corresponding to network activity at the location at a time, the set of devices comprising an access point (AP) device and user equipment (UE);
   analyzing, via a machine learning (ML) model, the collected data;
   generating, based on the ML-based analysis, an artificial intelligence (AI) model, the AI model being a location-specific model for the location; and
   communicating, over the network, the AI model to one of the set of devices at the location.
Aspect 2. The method of aspect 1, wherein the AP device downloads the AI model via the communication, wherein the AI model enables the AP to perform high frequency data sampling of network data at the location.
Aspect 3. The method of aspect 1, further comprising:
   causing, via the AP device, execution of the AI model to monitor and collect network data at the location.
Aspect 4. The method of aspect 3, further comprising:
   enabling, via execution of the AI model, configuration of a WiFi network at the location, the configuration corresponding to at least one of optimizing the WiFi network, modifying the WiFi network and mitigating issues with the WiFi network.
Aspect 5. The method of aspect 1, wherein the generation of the AI model is performed on a Cloud.
Aspect 6. The method of aspect 1, further comprising:
   training, based on the collected data, the ML model, the training enabling a specifically trained ML model for the location, wherein the collected data corresponds to an event detected at the location.
Aspect 7. The method of aspect 1, wherein the collected data corresponds to historical activity of each of the set of devices, the historical activity being a snapshot for each of the set of devices at the time, wherein the ML model is trained via the analysis based on the snapshot.

As used herein, the terms “computer engine” and “engine” identify at least one software component and/or a combination of at least one software component and at least one hardware component which are designed/programmed/configured to manage/control other software and/or hardware components (such as the libraries, software development kits (SDKs), objects, and the like).

Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. In some embodiments, the one or more processors may be implemented as a Complex Instruction Set Computer (CISC) or Reduced Instruction Set Computer (RISC) processors; x86 instruction set compatible processors, multi-core, or any other microprocessor or central processing unit (CPU). In various implementations, the one or more processors may be dual-core processor(s), dual-core mobile processor(s), and so forth.

Computer-related systems, computer systems, and systems, as used herein, include any combination of hardware and software. Examples of software may include software components, programs, applications, operating system software, middleware, firmware, software modules, routines, subroutines, functions, methods, procedures, software interfaces, API, instruction sets, computer code, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores,” may be stored on a tangible, machine readable medium and supplied to various customers or manufacturing facilities to load into the fabrication machines that make the logic or processor. Of note, various embodiments described herein may, of course, be implemented using any appropriate hardware and/or computing software languages (e.g., C++, Objective-C, Swift, Java, JavaScript, Python, Perl, QT, and the like).

For example, exemplary software specifically programmed in accordance with one or more principles of the present disclosure may be downloadable from a network, for example, a website, as a stand-alone product or as an add-in package for installation in an existing software application. For example, exemplary software specifically programmed in accordance with one or more principles of the present disclosure may also be available as a client-server software application, or as a web-enabled software application. For example, exemplary software specifically programmed in accordance with one or more principles of the present disclosure may also be embodied as a software package installed on a hardware device.

For the purposes of this disclosure the term “user”, “subscriber” “consumer” or “customer” should be understood to refer to a user of an application or applications as described herein and/or a consumer of data supplied by a data provider. By way of example, and not limitation, the term “user” or “subscriber” can refer to a person who receives data provided by the data or service provider over the Internet in a browser session, or can refer to an automated software application which receives the data and stores or processes the data. Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
collecting, over a network, data related to a set of devices at a location, the data corresponding to network activity at the location at a time, the set of devices comprising an access point (AP) device and user equipment (UE);
analyzing, via a machine learning (ML) model, the collected data;
generating, based on the ML-based analysis, an artificial intelligence (AI) model, the AI model being a location-specific model for the location; and
communicating, over the network, the AI model to one of the set of devices at the location.

2. The method of claim 1, wherein the AP device downloads the AI model via the communication, wherein the AI model enables the AP to perform high frequency data sampling of network data at the location.

3. The method of claim 1, further comprising:
causing, via the AP device, execution of the AI model to monitor and collect network data at the location.

4. The method of claim 3, further comprising:
enabling, via execution of the AI model, configuration of a WiFi network at the location, the configuration corresponding to at least one of optimizing the WiFi network, modifying the WiFi network and mitigating issues with the WiFi network.

5. The method of claim 1, wherein the generation of the AI model is performed on a Cloud.

6. The method of claim 1, further comprising:
training, based on the collected data, the ML model, the training enabling a specifically trained ML model for the location, wherein the collected data corresponds to an event detected at the location.

7. The method of claim 1, wherein the collected data corresponds to historical activity of each of the set of devices, the historical activity being a snapshot for each of the set of devices at the time, wherein the ML model is trained via the analysis based on the snapshot.

8. A system comprising:
a processor configured to:
collect, over a network, data related to a set of devices at a location, the data corresponding to network activity at the location at a time, the set of devices comprising an access point (AP) device and user equipment (UE);
analyze, via a machine learning (ML) model, the collected data;
generate, based on the ML-based analysis, an artificial intelligence (AI) model, the AI model being a location-specific model for the location; and
communicate, over the network, the AI model to one of the set of devices at the location.

9. The system of claim 8, wherein the AP device downloads the AI model via the communication, wherein the AI model enables the AP to perform high frequency data sampling of network data at the location.

10. The system of claim 8, wherein the processor is further configured to:
causing, via the AP device, execution of the AI model to monitor and collect network data at the location.

11. The system of claim 10, wherein the processor is further configured to:
enabling, via execution of the AI model, configuration of a WiFi network at the location, the configuration corresponding to at least one of optimizing the WiFi network, modifying the WiFi network and mitigating issues with the WiFi network.

12. The system of claim 8, wherein the generation of the AI model is performed on a Cloud.

13. The system of claim 8, wherein the processor is further configured to:
training, based on the collected data, the ML model, the training enabling a specifically trained ML model for the location, wherein the collected data corresponds to an event detected at the location.

14. The system of claim 8, wherein the collected data corresponds to historical activity of each of the set of devices, the historical activity being a snapshot for each of the set of devices at the time, wherein the ML model is trained via the analysis based on the snapshot.

15. A non-transitory computer-readable storage medium tangibly encoded with computer-executable instructions that when executed by a processor, perform a method comprising steps of:
collecting, over a network, data related to a set of devices at a location, the data corresponding to network activity at the location at a time, the set of devices comprising an access point (AP) device and user equipment (UE);
analyzing, via a machine learning (ML) model, the collected data;
generating, based on the ML-based analysis, an artificial intelligence (AI) model, the AI model being a location-specific model for the location; and
communicating, over the network, the AI model to one of the set of devices at the location.

16. The non-transitory computer-readable storage medium of claim 15, wherein the AP device downloads the AI model via the communication, wherein the AI model enables the AP to perform high frequency data sampling of network data at the location.

17. The non-transitory computer-readable storage medium of claim 15, further comprising:
causing, via the AP device, execution of the AI model to monitor and collect network data at the location; and
enabling, via execution of the AI model, configuration of a WiFi network at the location, the configuration corresponding to at least one of optimizing the WiFi network, modifying the WiFi network and mitigating issues with the WiFi network.

18. The non-transitory computer-readable storage medium of claim 15, wherein the generation of the AI model is performed on a Cloud.

19. The non-transitory computer-readable storage medium of claim 15, further comprising:
training, based on the collected data, the ML model, the training enabling a specifically trained ML model for the location, wherein the collected data corresponds to an event detected at the location.

20. The non-transitory computer-readable storage medium of claim 15, wherein the collected data corresponds to historical activity of each of the set of devices, the historical activity being a snapshot for each of the set of devices at the time, wherein the ML model is trained via the analysis based on the snapshot.
